(19) United States
(12) Patent Application Publication
(10) Pub. No.: US 2021/0254278 A1
(43) Pub. Date: Aug. 19, 2021

(54) Flame Retardant Fabric and Method

(71) Applicants: Daniel M. Honig, Forest Hills, NY (US); Larry Goldstein, Drayton, SC (US)

(72) Inventors: Daniel M. Honig, Forest Hills, NY (US); Larry Goldstein, Drayton, SC (US)

(21) Appl. No.: 16/790,723

(22) Filed: Feb. 13, 2020

(51) Int. Cl. D06N 3/00; D04B 1/16; D06N 3/04; A47C 31/00

(52) U.S. Cl. CPC D06N 3/0061; D04B 1/16; D06N 3/0009; D06N 3/0022; D06N 3/042; D06N 2209/067; D10B 2101/06; D06N 2201/082; D06N 2203/041; D06N 2203/066; A47C 31/001

(57) ABSTRACT

The invention is a flame-retardant fabric which includes a network of interconnected yarns. At least some of the yarns comprise fiberglass fibers. At least 30 weight percent, and preferably substantially all of the fiberglass fibers in the fabric are coated with a polymer composition comprising a fiberglass binding agent. The fabric of the present invention is used as a covering in furniture, such as a flame-retardant sock to surround the core of a mattress. The invention is also a method of producing a flame-retardant fabric. A fabric of interconnected yarns is provided. At least some of the yarns comprise fiberglass fiber. Those fiberglass fibers are coated with a coating composition comprising a polymer and a fiberglass bonding agent.

### CROSS-REFERENCE TO RELATED APPLICATION

The present application is a Continuation-in-Part of Application No. 62/805,676, filed Feb. 14, 2019 and having the same title. The entire disclosure of this prior application is incorporated herein by reference.

### TECHNICAL FIELD

The present invention relates to textiles and fabric, and particularly to fabrics that possess flame-retardant properties.

### BACKGROUND

Flame-retardant coverings for mattresses are known in the art and a crucial safety measure. The U.S. National Fire Protection Association (NFPA) estimates that during 2005-2009, a mattress or bedding was the item first ignited in an average of 10,260 reported home structure fires every year. As annual averages during the period of this study, the fires caused an estimated average of 371 civilian deaths, 1,340 civilian injuries, and $382 million in property damage.

Numbers of these type have prompted regulatory efforts from the U.S. government to reduce the flammability of mattresses, upholstered furniture and bedclothes used in homes and hospitals. In particular, residential mattresses are subject to two federal flammability standards administered by the Consumer Product Safety Commission (CPSC). These standards can be found in the code of federal regulations at 16 C.F.R. Parts 1632 and 1633, which are often referred to as Parts 1632 and 1633.

The majority of fuel in the typical mattress is the filling material which provides the consumer with comfort and support. The filling material is normally made of polyurethane or other types of foam. Alternatively, some filling material is made of natural or synthetic fibers, or combinations of materials. Unfortunately, all of these materials are combustible. Consequently, the typical strategy is to keep these combustible materials from being ignited by surrounding them with flame-retardant materials.

To meet Part 1632, manufacturers typically enclose the filling materials with fabrics that do not allow smoldering cigarettes to burn through the outer mattress surface to the filler materials. For example, most mattress manufacturers use an outer fabric made from conventional fibers (e.g. polyester, polyolefin, wool, silk) that resist ignition from a smoldering cigarette.

Meeting Part 1633 is more demanding, as it was implemented to stop fires ignited by an open flame, such as lighters, matches and candles. These standards are often met by employing a fabric barrier to protect the filler material and other material from igniting. Such barriers are designed to block either heat, oxygen or both from reaching the filler material. Such barriers, are often referred to as a “sock, “mattress sock,” “fire sock” or “fire barrier sock.” These are usually made from woven or knit fabrics, or non-woven fiber pads. These fabrics may be sewn into the mattress between the ticking cover and the interior upholstery material. They may also be designed into the outer fabric cover. The barriers are made from a variety of natural and synthetic fibers. Often, these fabrics protect the mattress by forming a char when exposed to a flame.

Fiberglass has often been used in these flame-retardant fabrics for protective clothing and for furniture. It is a relatively inexpensive material and its flame-retardant properties are well known. In particular, it has found use in flame-retardant mattress socks. See, for example, U.S. Pat. No. 5,540,980, which discloses mattress covers made from yarns with fiberglass filaments as the core and other materials as the sheath. See also U.S. Pat. No. 7,484,256, which discloses a char-forming, inherently flame-retardant fibers, such as fiberglass. See also U.S. Pat. No. 8,163,664, which describes a “veil” of fiberglass material surrounding the mattress core.

However, even with precautions taken, fiberglass can pose health problems. For example, if, through normal or abnormal wear, fiberglass fibers escape the fabric and mattress construction, they can cause skin, eye, upper respiratory tract and even stomach irritation. Various types of fiberglass fibers have also been identified as carcinogenic.

In addition, exposed fiberglass in the fabric can interfere with the comfort properties, e.g. the weight and hand, of the fabric. For this reason, the U.S. Pat. No. 5,540,980 referred to above, only included fiberglass filaments surrounded by other fibers.

U.S. Published Patent Application No. 2018/0220807, which shares one common inventor with the present application, discloses one solution to these potential problems, which is to construct the fabric for a flame-retardant mattress sock without any fiberglass fibers.

### SUMMARY

In a first aspect, the invention is a flame-retardant fabric which includes a network of interconnected yarns. At least some of the yarns comprise fiberglass fibers. At least 30 weight percent of the fiberglass fibers in the fabric are coated with a polymer composition comprising a fiberglass binding agent. Preferably, at least 50 percent of the fiberglass fibers in the fabric are coated, more preferably, at least 80 percent and even more preferably, at least 95 percent are coated.

Preferably the fabric is knitted from some yarns that are formed entirely of fiberglass fibers and substantially all of those fiberglass fibers are coated with the polymer composition. Preferably, the fabric of the present invention is used as a covering in furniture. Most preferably, the fabric of the invention is used as a flame-retardant barrier (often referred to as a “sock”) to surround the core of a mattress.

In a second aspect, the invention is a method of producing a flame-retardant fabric. A fabric of interconnected yarns is provided. At least some of the yarns comprise fiberglass fiber. Those fiberglass fibers are coated with a coating composition comprising a polymer and a fiberglass bonding agent.

Preferably, the coating composition is applied to the fabric from an aqueous bath and then dried.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is schematic representation of the preferred method of applying the coating composition.

FIG. 2 is a schematic cross-sectional view of a mattress with a flame-retardant sock around a foam core.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

Unless specified otherwise, the terms “percent” and “%” are intended to refer to percent by weight or wt %.

As used herein, the term “fabric” is intended to have its ordinary meaning and refers to a material made through knitting, weaving, spreading, crocheting, or bonding of yarns.

As used herein, the term “yarn” is intended to refer to a long continuous length of interlocked fibers, suitable for use in the production of fabric. For the purposes of this disclosure, the terms “thread” and “string” are not distinguished from yarn.

As used herein, the term “fiber” is intended to refer to a natural or synthetic substance that is longer than it is wide. Fibers can be obtained from natural sources, such as cotton or wool. Fibers can also be obtained from synthetic sources and may be formed by various processes, such as extrusion, spinning or melt blowing. While some distinguish between fibers and filaments, for the purposes of this disclosure, filaments are included within the term fibers.

As used herein, the term “fiberglass” is intended to have its usual meaning, namely a material consisting of fine fibers or filaments of glass that, for the purposes of this invention can be combined in yarn and woven or otherwise converted into a fabric.

Overview

The present invention provides a flame-retardant fabric that takes advantage of the excellent flame-retardant properties and low cost of fiberglass fibers. One aspect of the invention is to coat the fiberglass fibers with a polymer composition, preferably to encapsulate the fiberglass fibers. While not wishing to be bound by a particular theory, it is currently believed that coating and encapsulating the fiberglass fibers serves to keep them locked into the fabric, even after long periods of normal and preferably heavy use. This is particularly beneficial for the preferred embodiment when the fabric is used to construct a flame-retardant mattress sock, as the harmful health effects of loose fiberglass fibers can be averted, or at least reduced. To achieve this benefit, it is most preferred that all, or substantially all of the fiberglass fibers are coated. At a minimum, at least 30 percent should be coated. Preferably, at least 50 percent are coated, more preferably at least 80 percent are coated and even more preferably, at least 95 percent of the fiberglass fibers are coated.

By coating at least 30 percent and most preferably substantially all of the fiberglass fibers with a polymer composition having a polymer and a fiberglass binding agent, a flame-retardant fabric is provided with reduced concerns over any ill effects of free fiberglass fibers. Moreover, as the fiberglass fibers are selectively coated in the preferred embodiment, the other yarns in the fabric are allowed to maintain their inherent physical properties. In other words, it is preferred that the other fibers should not end up coated, and should not appreciably gain bulk or stiffness in the coating process. Consequently, the flame-retardant fabric is preferably produced without negative effects on the comfort properties of the fabric, namely weight and hand.

Alternatively, the coating composition may be selected to intentionally modify the weight and hand of the ultimate fabric. In some embodiments, the coating composition can be formulated and applied so as to add bulk or stiffness to the fabric. The precise impact on the fabric can be influenced by proper selection of additives, such as plasticizers and or fillers. The impact can also be influenced by controlling the amount of coating composition is picked up by the fabric.

Another important component of the coating composition is a fiberglass binding agent., that is a chemical agent that helps the polymer adhere to the fiberglass fibers. Such agents may also be referred to as cross-linking agents. Nevertheless, not all cross-linking agents are suitable. Only those that link the fiberglass fibers to the polymer are desired.

Again, while not wishing to be bound by a particular theory, it is believed that the fiberglass binding agent aids in the selective binding of the polymer to the fiberglass fibers in the fabric. The benefit is that the fiberglass fibers are more securely encapsulated and locked into the fabric. In addition, since the fiberglass binding agent is believed to help the coating composition selectively bind to the fiberglass fibers, the amount of polymer can be reduced, compared to the amount needed if the polymer were binding non-selectively to all the fibers in the fabric. This lower amount of polymer helps keep the cost of the fabric down. It also ensures that the polymer has less effect on the weight and hand of the final fabric.

Fibers and Yarn

Fiberglass is often made by a process known as pultrusion, whereby molten silica is extruded to fine filaments and sized. Another process for producing fiberglass fibers is known as the melt blowing or melt-blown process, wherein molten silica is extruded through small nozzles surrounded by high speed blowing gas.

The yarn used in the fabric may be made through any suitable process, such as twisting or spinning. At least some of the yarns comprise fiberglass fibers. Preferably, some of the yarns are made entirely from fiberglass. More preferably, these fiberglass yarns consist of bundles of fiberglass filaments, with a denier between 50 and 300. Most preferably, these fiberglass yarns are purchased from B&W Fiberglass as either D450 (denier of 100) or E225 (denier of 200).

In the preferred embodiment wherein some of the yarns are made entirely of fiberglass, such fiberglass yarns are knitted or woven with other yarns made from natural or synthetic fibers. For example, these other yarns can be made from cotton, flax, jute, hemp, polyester, nylon, rayon, silica loaded rayon, acrylic, and mixtures thereof. Preferably these other yarns are made from cotton.

In an alternative embodiment, the fiberglass fibers are blended into yarns with other types of natural or synthetic fibers. In this alternative embodiment, the fiberglass fibers may be blended into all the yarns in the fabric or may be blended into only some of the yarns.

In some embodiments, the fiberglass containing yarns and/or the other yarns may have inherently flame-retardant fibers—other than fiberglass—incorporated into the yarn. Examples of these other inherently flame-retardant fibers include the following: aramids, including para aramids (poly(p-phenylene terephthalamide), e.g., KEVLAR® (Dupont Corporation) and meta-aramids (poly(m-phenylene isophthalamide), such as Nomex® (Dupont Corporation); melamines such as BASOFIL® (BASF/Mckinnon-Land-Moran, LLC); poly benzimidazole (PBI) (Celanese Acetate AG); oxidized poly acrylonitrile (PAN); novoloids, such as KYNOL® (American Kynol, Inc); pre-oxidized fibers and carbon fibers, modacrylics, such as, e.g., KANECERON® and PROTEX® (Kaneka), SEF (Solutia) and LUFNENR) (Kanebo Goshen), FR (fire- or flame-resisting, -resistant, -retarding or -retardant) rayon, FR viscose, such as, e.g., VISIL® (Sateri Oy) and LENZING FR® (Lenzing AG, Fibers Division), and wool.

The denier of the yarns used to make the fabric is selected with the end use in mind. Naturally, a lower denier will make a thinner, finer fabric, while a higher denier will produce a heavier, coarser fabric. In the preferred embodiment, wherein the fabric is used for a flame-retardant sock for a mattress, the denier of the yarns should be between 100 and 400, more preferably between 200 and 300, and most preferably about 250.

Forming the Fabric

The fabric of the present invention is preferably made by knitting the yarns.

Conventional knitting processes can be used. Naturally, the pattern and other properties of the knitting operation are selected depending on the end use of the fabric being produced. Most preferably, the fabric is knitted with a construction generally referred to as a double knit or rib knit. Alternatively, other knit constructions, such as jersey knit, can be used.

In the preferred knitted embodiment, wherein some of the yarns are made entirely from fiberglass, the fiberglass yarns can be used at between 30 and 80 percent of the total yarns in the resultant fabric, more preferably between 40 and 60 percent and most preferably about 50 percent.

Alternatively, the fabric is knit from yarns, either all of which or only some of which have fiberglass blended in with other natural or synthetic fibers. In such an embodiment, the yarns are preferably designed so that the fiberglass content of the resultant fabric is between 30 and 80 percent by weight of the fabric, more preferably between about 40 and 60 percent and most preferably about 50 percent.

In alternative embodiments, the fabric is made by weaving. Suitable weave patterns include plain, twill, satin, basketweave and leno. Again, the pattern is selected based on the end use of the fabric. In these alternative embodiments, wherein the fabric is made by weaving, the preferred method makes use of some of the yarns being entirely fiberglass, while others are made from other natural or synthetic fibers. Still alternatively, the yarns can be made so that all or some of the yarns contain a blend of fiberglass fibers with other fibers.

The properties of the yarn and the specifications for knitting or weaving are selected based on the desired properties of the finished fabric, e.g. the hand and weight of the fabric. In the preferred embodiment, wherein the fabric is used as a flame-retardant sock for a mattress, the hand of the fabric should be soft. Also, in the preferred embodiment, the weight of the fabric should not be too heavy, so as to not affect the comfort of the mattress and so as not to add too much cost to the mattress.

Coating Composition—Polymer Component

The polymer employed in the composition can be selected from a wide variety of polymers and polymer families, together with combinations thereof. Suitable polymer families include acrylic, vinyl acrylic, styrene acrylic, urethane acrylic, urethane, silicone acrylic urethanes, polystyrenes, ethylene vinyl acetates, and silicone. Preferably, the polymer is an acrylic urethane, most preferably an acrylic urethane available from GTI Chemical Solutions as GTI Cryl 65088. This product is a 55% Acrylic-urethane emulsion polymer with a Tg−12° C., pH 2.5—4.0 and a particle size of 0.28 microns.

Preferably, the polymer is one that can be applied to the fabric from an aqueous bath, in the form of a solution, emulsion or dispersion. Such an aqueous bath is preferably made up with between 5 and 20 percent of the polymer, more preferably between 5 and 10 percent polymer and most preferably about 10 percent polymer.

The polymer used in the coating composition and the amount applied to the fiberglass fibers are preferably selected so as to either enhance or at least not detract from the properties of the final flame-retardant fabric. Preferably, the polymer does not add too much weight or stiffness to the fabric.

Fiberglass Binding Agent

Several fiberglass binding agents are available in the market. Suitable fiberglass binding agents include siloxanes, melamine formaldehyde, and carbodiimide. Currently, the preferred fiberglass binding agent is a siloxane, most preferably, a siloxane described as aminopropyl disiloxil silane, available to purchase from GTI Chemical Solutions, Inc. under the designation GTI Silanadd 1100.

Naturally, the amount of fiberglass binding agent depends on the agent selected, as well as the particular polymer and the amount of fiberglass fibers in the fabric. When the polymer is the acrylic urethane mentioned above, and when the fiberglass binding agent is the siloxane mentioned above, the agent is preferably present between 3 and 13 percent by weight of the fiberglass fibers, more preferably between 3 and 5 percent and most preferably about 3 percent. Stated another way, the fiberglass binding agent is present between 6.25 and 27.10 by weight of the aqueous coating bath, more preferably between 6.25 and 10.42 percent and most preferably about 6.25 percent.

Other Components of the Coating Composition

The coating composition can be used to add other components to the fabric, in addition to the polymer and fiberglass binding agent. In some embodiments, the coating composition is also used to add flame-retardant agents to the fabric. Suitable flame-retardant agents include, and are not limited to the following: mono and diammonium phosphate, poly ammonium phosphate, ammonium bromide, ammonium chloride, boric acid, borax, ammonium borate, ethanolammonium borate, phosphate or Sulfamate, ammonium Sulfamate, organic phosphate esters, halogenated organic compounds like decabromodiphenyl oxide, chlorinated or brominated paraffin, chlorinated or brominated binders, thiourea, hydrated alumina, graphite, antimony oxides. Preferably, if such a compound is added to the coating composition, it is selected from mono, di or poly ammonium phosphate.

Plasticizers are added to affect the flexibility of the dried coating composition, and thus the hand of the resultant fabric. Conventional plasticizers can be used, with dioctyl adipate (DOA) and dibutyl terephthatlate (DBT) being most preferred.

Other components that can be added to the coating composition include surfactants, wetting agents, pH modifiers, stabilizing agents, dyes, anti-microbials, organic solvents, sequestering or chelating agents and catalysts, etc. Surfactants are used to stabilize the polymer particles in water during emulsification. Catalysts are sometimes added to functional polymers to provide cross-linking and impart heat and chemical resistance.

Methods of Applying the Coating Composition

At present, it is preferred to first form the fabric of the invention, such as by knitting or weaving yarns which contain fiberglass fibers, and then apply the coating composition to the fabric. In alternative embodiments, the coating is applied to yarns containing fiberglass fibers before the yarns are formed into the fabric.

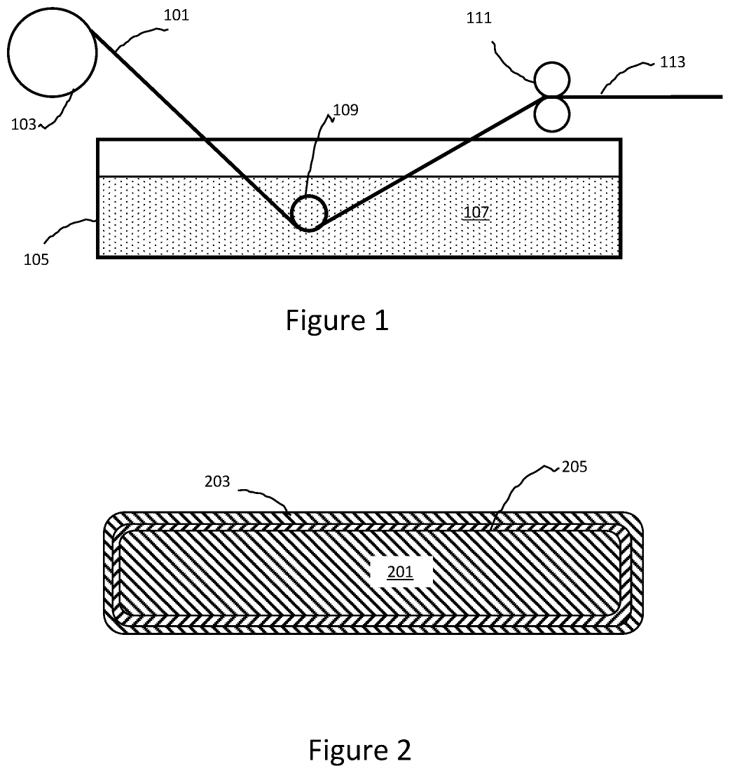

FIG. 1 illustrates a suitable technique for applying the coating. The fabric 101 is unrolled from the roll 103 and passes into a vat 105 containing the aqueous coating composition 107 and around the bottom of the roller 109. Leaving the vat, the fabric passes through the pair of pressure rollers 111, whereupon excess coating composition is pressed from the fabric. The coated fabric 113 is then dried and rolled up for later use.

The coating composition can also be applied by other methods, such as by printing, spraying, foaming, etc.

Preferably, the coating method is used to add between 10 and 30 percent dry weight percent of components to the fabric, more preferably between 15 and 20 percent and most preferably about 18 percent.

Applications for the Flame-Retardant Fabric

The flame-retardant fabric of the present invention will find many uses. One area is that of making articles of protective clothing. Shirts, pants, jackets coats, masks and gloves can all be made from the fabric of the invention. One advantage of the preferred embodiment is that the desirable hand and weight of the fabric can be achieved. Another advantage is that the fiberglass component, given its superior tensile strength, can be used to impart cut and tear resistance to the fabric. As such, articles such as gloves and jackets can provide even more protection to the wearer.

Another area for application of the flame-retardant fabric of the present invention is in the protective covering of flammable padding used in furniture items. For example, the padding for cushions on chairs, sofas, automobile seats and others can be covered to prevent ignition of that padding.

Construction of a Flame-Retardant Mattress Sock

The most preferred application for the flame-retardant fabric of the present invention is its use in a protective cover for a mattress core, i.e. flame-retardant mattress sock. FIG. 2 illustrates a simple construction of a flame-retardant mattress sock. The core of the mattress 201 is preferably made from a polyurethane foam. That core 201 is surrounded by the flame-retardant mattress sock 203 of the present invention. Preferably, the fabric of the invention is sewn into the appropriate size and shape to enclose the core. The outer covering 205 surrounds the sock 203 and core 201.

### EXAMPLES

The present invention is further illustrated by the following examples which are included solely for illustrative purposes and are by no means intended to limit the scope of the appended claims.

A flame-retardant mattress sock was made according to the most preferred embodiment described above. A mattress core with that sock was then tested as follows:

### Example 1

### Flame-retardant Tests (Part 1633)

Brief Description of Test: A mattress set is placed on a support system. Flames from a multi-hole propane burner impinge on the side of the mattress set for a period of 50 seconds, and flames from a second multi-hole burner impinge on the top of the mattress set for a period of 70 seconds. The recording instrumentation in the exhaust duct evaluates the combustion product and a formula calculates the highest heat release value recorded during the test period. It also records the total heat released during the entire test. The test continues until failure occurs or 30 minutes have elapsed. Five test categories are available, namely Qualified Prototype, Confirmed Prototype, Subordinate Prototype, Production Quality Control and Experimental.

Results: The mattress set outfitted with the flame-retardant mattress sock made as described above passed this test.

Durability Test (Rollator)

A “rollator” test (ASTM F1566, Part 7) was conducted to evaluate the durability of the fabric of the flame-retardant mattress sock made as described above in accelerated wear conditions. The results showed satisfactory wear results after 45,000 cycles.

### Example 2 and Comparative Example

### Additional Rollator Testing

A flame-retardant mattress sock for Example 2 and its Comparative Example were made as follows:

The fabric in Example 2 comprised 9% polyester, 42% cotton and 49% fiberglass. This fabric was treated with an aqueous coating composition comprising:

Coating Composition for Example 2

| Ingredient | Wt % |
|---|---|
| GTI Tard FFR-2 | 35 |
| GTI Terg 361 | 1 |
| GTI Cryl 65088 | 5 |
| Silanadd 1100 | 1 |
| Water | balance |

GTI Tard FFR-2 was obtained from GTI Chemical Solution, Inc. (GTI), and comprises ammonium polyphosphate.

GTI Terg 361 is a wetting agent from GTI and comprises a phosphate ester.

GTI Cryl 65088 is an acrylic urethane emulsion from GTI.

Silanadd 1100 is a bifunctional silane coupling agent from GTI.

This coating composition was applied to the fabric as described above, so as to give about a 10 to 20 wt % add when dried.

A Comparative Example was prepared by forming a fabric comprising 8% rayon, 9% nylon, 35% modacrylic and 48% fiberglass. This fabric was not coated.

The coated fabric and the uncoated fabric were then each made into a mattress sock and subjected to the rollator test as described below.

A Mattress Rollator Tester (Rollator) was used that meets the requirements of ASTM F1566 Section 7, Durability Test. This durability test uses a 240 pound hexagonal roller across the width of the mattress to simulate long term usage of a mattress. A modified version of this test was conducted using the Rollator In each case the mattress socks were put over the mattress and subjected to 45,000 cycles of the Rollator.

Visual observation of the socks made from the coated and uncoated fabric after 45,000 cycles showed significant differences. The sock made from the uncoated fabric showed much more wear and thinning than the sock made from the coated fabric. A significant amount of loose fiberglass particles was observed on the mattress after the sock from the uncoated fabric was removed. No loose fiberglass particles were observed on the mattress after the sock from the coated fabric was removed.

As a result of these observations, it was concluded that the presence of inventive coating appears to reduce the impact of abrasion to the mattress sock when subjected to Rollator testing, which simulates real-life wear and tear to a mattress. Also, and perhaps more importantly, the coating of the fabric was observed to reduce the amount of fiberglass that is loosened from the mattress sock through the action of the rollator.

### Example 3 and Comparative Example

### Martindale Abrasion

A flame-retardant mattress sock for Example 3 and its Comparative Example were made as follows:

The fabric in Example 3 comprised 16% polyester, 39% cotton and 45% fiberglass. This fabric was treated with an aqueous coating composition comprising

Coating Composition for Example 3

| Ingredient | Wt % |
|---|---|
| GTI Tard FFR-2 | 35 |
| GTI Terg 361 | 1 |
| GTI Cryl 55545 | 5 |
| GTI Cryl 777 | 5 |
| Silanadd 1100 | 1 |
| GTI Plasticizer DOA | 0.083 |
| Water | balance |

GTI Cryl 55545 is a styrene acrylic emulsion from GTI.

GTI Cryl 777 is an acrylic emulsion from GTI.

GTI Plasticizer DOA is a dioctyl adipate from GTI

This coating composition was applied to the fabric as described above, so as to give about a 10 to 20 wt % add when dried.

A Comparative Example was prepared by forming a fabric comprising 8% rayon, 9% nylon, 35% modacrylic and 48% fiberglass. This fabric was not coated.

The coated fabric from Example 3 and the uncoated fabric were subjected to Martindale abrasion treatment in accordance with ASTM D4966, with 9 Kpa and 2,000 cycles. The fiberglass content of the two fabrics was measured before the abrasion treatment by ashing and gravimetric analysis of 12 specimens. The fiberglass content of the two fabrics was measured after the abrasion treatment by ashing and gravimetric analysis of 4 post-abrasion specimens. The results shows that the uncoated fabric lost an average of 13.86 wt % of its fiberglass content, while the coated fabric lost an average of only 6.56 wt %.

### Example 5 and 6 and Comparative Example

### Tabor Abrasion

A flame-retardant mattress sock for Example 3 and its Comparative Example were made as follows:

The fabric in Example 4 comprised 9% polyester, 42% cotton and 49% fiberglass. This fabric was treated with an aqueous coating composition comprising:

Coating Composition for Example 4

| Ingredient | Wt % |
|---|---|
| GTI Tard FFR-2 | 35 |
| GTI Cryl 55545 | 5 |
| GTI Cryl 777 | 5 |
| Silanadd 1100 | 1 |
| GTI Plasticizer DOA | 0.083 |
| Water | balance |

This coating composition was applied to the fabric as described above, so as to give about a 10 to 20 wt % add when dried.

The fabric in Example 5 comprised 16% polyester, 39% cotton and 45% fiberglass. This fabric was treated with an aqueous coating composition comprising:

Coating Composition for Example 5

| Ingredient | Wt % |
|---|---|
| GTI Tard FFR-2 | 35 |
| GTI Terg 361 | 1 |
| GTI Cryl 55545 | 5 |
| GTI Cryl 777 | 5 |
| Silanadd 1100 | 1 |
| GTI Plasticizer DBT | 0.15 |
| Water | balance |

GTI Plasticizer DBT is a dibutyl terephthalate plasticizer from GTI.

This coating composition was applied to the fabric as described above, so as to give about a 10 to 20 wt % add when dried.

A Comparative Example was prepared by forming a fabric comprising 8% rayon, 9% nylon, 35% modacrylic and 48% fiberglass. This fabric was not coated.

The coated fabric from Examples 4 and 5 and the uncoated fabric were subjected to Tabor abrasion treatment in accordance with ASTM D3884 with a H-38 CWheel and a 250g load. This test method exposes a fabric to continuous abrasion and is measured in the number of cycles it takes to create two broken yarns in the material being abraded. The higher the number of cycles, the better the abrasion result. The test was run in triplicate for the uncoated fabric of Comparative Example, which had two broken yarns after an average of 267 cycles. The test was run twice for the coated fabric of Example 4, which had two broken yarns after an average of 413 cycles. The test was run in triplicate for the coated fabric of Example 5, which had two broken yarns after an average of 483 cycles. From these results, it was observed that the inventive coating increased the abrasion resistance of the fabric.

Visual observation revealed that the coated fabric of Example 5 had less loosened fiber than the uncoated fabric of the Comparative Example. It was also observed that the fiber that was loosened from the fabric of Example 5 was compact and could not be broken up. Conversely, the uncoated fabric of the Comparative Example had a much larger amount of loosed fiber, while the fibers that were loosened were very puffy and easily went into the air when disturbed.

### CONCLUSION

All patents and published patent applications referred to herein are incorporated herein by reference.

The invention has been described with reference to various specific and preferred embodiments and techniques. Nevertheless, it is understood that many variations and modifications may be made while remaining within the spirit and scope of the invention.

What is claimed is:

1. A flame-retardant fabric comprising
a network of interconnected yarns, wherein at least some of the yarns comprise fiberglass fibers, and wherein at least 30 weight percent of the fiberglass fibers are coated with a polymer composition comprising a fiberglass binding agent.

2. The invention of claim 1, wherein at least 50 weight percent of the fiberglass fibers are coated with a polymer composition comprising a fiberglass binding agent.

3. The invention of claim 1, wherein at least 80 weight percent of the fiberglass fibers are coated with a polymer composition comprising a fiberglass binding agent.

4. The invention of claim 1, wherein at least 95 weight percent of the fiberglass fibers are coated with a polymer composition comprising a fiberglass binding agent.

5. The invention of claim 1, wherein the polymer composition comprises between 5 and 15 percent by weight of the fabric and the fiberglass binding agent comprises between 3 and 13 percent by weight of the fiberglass fibers.

6. The invention of claim 1, wherein the polymer composition comprises a polymer selected from the group consisting of acrylic urethanes, urethanes, acrylics, silicones, and ethylene vinyl acetates.

7. The invention of claim 6, wherein the polymer comprises an acrylic urethane.

8. The invention of claim 1, wherein the fiberglass binding agent is selected from the group consisting of siloxanes, melamine formaldehyde, carbodiimide and mixtures thereof.

9. The invention of claim 8, wherein the fiber glass binding agent is a siloxane.

10. The invention of claim 9, wherein the siloxane is aminopropyl disiloxil silane.

11. The invention of claim 1, wherein some of the yarns are formed entirely of fiberglass.

12. The invention of claim 11, wherein the fiberglass is present in the form of filaments.

13. The invention of claim 11, wherein the yarns formed entirely of fiberglass comprise between 30 and 80 percent by weight of the fabric.

14. The invention of claim 1, wherein the flame-retardant fabric is a knitted fabric comprised of yarns formed entirely of fiberglass and yarns comprising natural or synthetic fibers.

15. The invention of claim 1, wherein at least some of the yarns comprise fibers of inherently flame-retardant materials other than fiberglass.

16. The invention of claim 1 wherein the fabric also contains at least one flame-retardant additive selected from the group consisting of monoammonium phosphate, diammonium phosphate and ammonium polyphosphates.

17. A method of producing a flame-retardant fabric comprising:
providing a fabric of interconnected yarns, wherein at least some of the yarns comprise fiberglass fibers;
coating the fiberglass fibers with a coating composition comprising a polymer and a fiberglass bonding agent.

18. The method of claim 17, wherein the coating composition is applied to the fabric in an aqueous state and then dried.

19. The method of claim 17, wherein the fabric is formed by knitting.

20. The method of claim 19, wherein the at least some of the yarns are formed entirely of fiberglass.

21. The method of claim 20, wherein the yarns formed entirely of fiberglass comprise between about 30 and about 80 percent by weight of the fabric.

22. The method of claim 17, wherein the coating composition is applied to the fiberglass fibers by application of the coating composition to the at least some of the yarns comprising fiberglass before the fabric is formed.

23. The invention of claim 17, wherein the coating composition is constituted so that the polymer comprises between 5 and 15 percent by weight of the fabric and so that the fiberglass binding agent comprises between 3 and 13 percent by weight of the fiberglass fibers.

24. The invention of claim 14, wherein the polymer composition comprises a polymer selected from the group consisting of acrylic urethanes, urethanes, acrylics, silicones, and ethylene vinyl acetates.

25. The invention of claim 24, wherein the polymer comprises an acrylic urethane.

26. The invention of claim 17, wherein the fiberglass binding agent is selected from the group consisting of siloxanes, melamine formaldehyde, carbodiimide and mixtures thereof.

27. The invention of claim 26, wherein the fiber glass binding agent is a siloxane.

28. The invention of claim 27, wherein the siloxane is aminopropyl disiloxil silane.

29. The invention of claim 17, wherein some of the yarns are formed entirely of fiberglass.

30. The invention of claim 29, wherein the fiberglass is present in the form of filaments.

31. The invention of claim 29, wherein the yarns formed entirely of fiberglass comprise between 30 and 80 percent by weight of the fabric.

32. The invention of claim 17, wherein the flame-retardant fabric is a knitted fabric comprised of yarns formed entirely of fiberglass and yarns comprising natural or synthetic fibers.

33. The invention of claim 17, wherein at least some of the yarns comprise fibers of inherently flame-retardant materials other than fiberglass.

34. The invention of claim 17 wherein the fabric also contains at least one flame-retardant additive selected from the group consisting of monoammonium phosphate, diammonium phosphate and ammonium polyphosphates.

35. A protective cover for a foam pad made from the fabric of claim 1.

36. The invention of claim 35, wherein the foam pad is a foam mattress core.

37. A protective cover for a foam pad, wherein the fabric is made by the method of claim 17.

38. The invention of claim 37, wherein the foam pad is a foam mattress core.
